(19) United States
(12) Patent Application Publication
(10) Pub. No.: US 2026/0169703 A1
(43) Pub. Date: Jun. 18, 2026

(54) SOFTWARE SOLUTION AND PLATFORM THAT INTEGRATES AND COMBINES MULTIPLE INTERCHANGEABLE SOFTWARE COMPONENTS USING CUSTOM DATA PIPES

(71) Applicant: Acumen Analytics, Springhouse, PA (US)

(72) Inventors: Kathleen BRUNNER, North Wales, PA (US); George BRUNNER, North Wales, PA (US)

(73) Assignee: Acumen Analytics, Springhouse, PA (US)

(21) Appl. No.: 19/421,592

(22) Filed: Dec. 16, 2025

Related U.S. Application Data
(60) Provisional application No. 63/734,541, filed on Dec. 16, 2024.

(51) Int. Cl. G06F 8/34

(52) U.S. Cl. CPC G06F 8/34

(57) ABSTRACT

Disclosed herein is a software solution and platform that integrates and combines multiple interchangeable software components using custom data pipes. The software solution and platform, as well as the multiple interchangeable software components, can include machine learning (ML), artificial intelligence (AI), and generative AI. The software solution and platform is a processor executable code or software that is necessarily rooted in process operations by, and in processing hardware of, computing equipment. For ease of explanation, the software solution and platform is described herein with respect to an integration engine.

### CROSS-REFERENCE TO RELATED APPLICATIONS

This application claims priority to provisional U.S. Application No. 63/734,541, filed Dec. 16, 2024, the contents of which are hereby incorporated by reference in their entirety.

### BACKGROUND

Conventional technology provides piecemeal software solutions corresponding to individual aspects of everyday business needs. Further, conventional technology creates and processes separate and disparate data that directly relate to these individual aspects of the everyday business needs. Yet, conventional technology requires hours of special coding, processing time, and manual review of the separate and disparate data. A solution is needed for integrating piecemeal software solutions with new software, while connecting the corresponding separate and disparate data.

### SUMMARY

According to an exemplary embodiment, a method is provided. The method can integrate and combine multiple interchangeable software components using custom data pipes.

According to one or more embodiments, a method embodiment above can be implemented as an apparatus, a system, a software solution, a platform, and/or a computer program product.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 illustrates a system according to one or more embodiments;

FIG. 2 illustrates system diagrams according to one or more embodiments;

FIG. 3 illustrates an integration engine according to one or more embodiments;

FIG. 4 illustrates a logical architecture according to one or more embodiments;

FIG. 5 illustrates a method according to one or more embodiments;

FIG. 6 illustrates a method according to one or more embodiments; and

FIG. 7 illustrates a diagram according to one or more embodiments.

### DETAILED DESCRIPTION

Disclosed herein is a software solution and platform that integrates and combines multiple interchangeable software components using custom data pipes. The software solution and platform, as well as the multiple interchangeable software components, can include machine learning (ML), artificial intelligence (AI), and generative AI. The software solution and platform is a processor executable code or software that is necessarily rooted in process operations by, and in processing hardware of, computing equipment. For ease of explanation, the software solution and platform is described herein with respect to an integration engine.

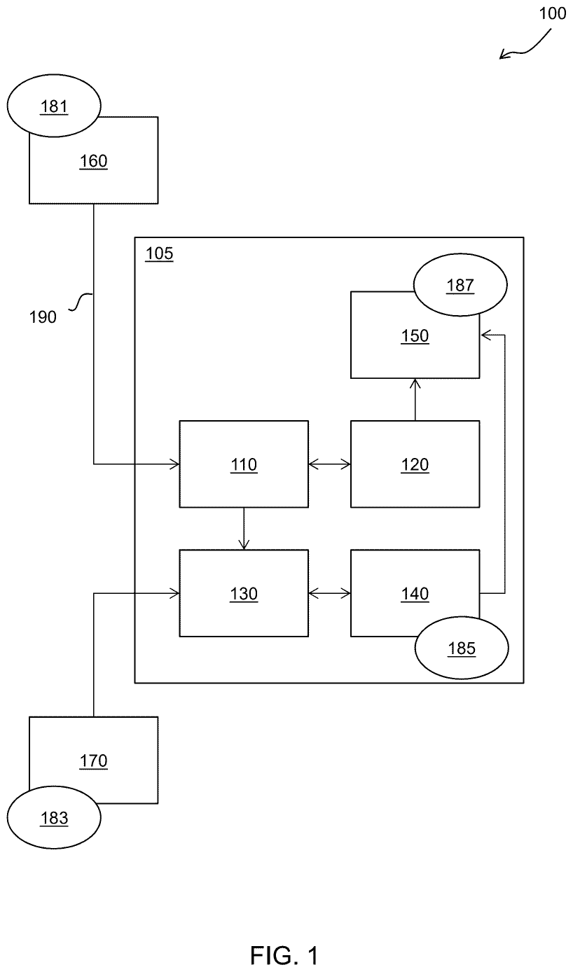

FIG. 1 is a diagram of an example software solution and platform (e.g., computing equipment), shown as a system 100, in which one or more features of the subject matter herein can be implemented according to one or more embodiments. All or part of the system 100 can be used to perform discover, digest, compose, analyze, and report operations and/or used to implement machine learning and/or artificial intelligence (ML/AI) in support thereof.

The system 100, as illustrated, includes an integration engine 105. The integration engine 105 is a component architecture with modules for data ingestion, transformation, composition, analysis, and reporting. Accordingly, the integration engine 105 can perform discover, digest, compose, analyze, and report operations and/or be used to implement machine learning and/or artificial intelligence (ML/AI) in support thereof. According to one or more embodiments, the system 100 and the integration engine 105 are a modular architecture enabling efficient integration/swapping of ML/AI models, tools, and data pipes, as well as providing scalability. A data pipe is a custom connector of the system 100 and the integration engine 105 that provides a resilient, traceable, auditable, and transparent path that directly matches data from sources to results and/or analyses. By way of example, a data pipe acts as a ‘wormhole’ or computer structure of the integration engine 105 that connects two distant points across the system 100. Further, each data pipe includes the technical effects, advantages, and benefits of being specifically tuned to get or obtain specific data from within all available unstructured and structured data (rather than the entirety of the data) and routes to an output (e.g., results, report document, and/or analyses). By way of another example, a data pipe transforms specific data into a format (to streamline the data) or a variety of formats (results, report document, and/or analyses) based on use case or requirements. Accordingly, the data pipes with models of the system 100 and the integration engine 105 are “tuned specifically” for the use case or requirements (e.g., clinical trials, supply chain, patient journeys, total product quality, etc.), and the entirety of the data is avoided to gain processing efficiencies. By way of example, the data pipes are beyond the capabilities of conventional audit trails because the data pipes follow data transformation and tagging from unstructured data to structured data to provide decision intelligence.

The integration engine 105 includes a discover and digest module 110, a compose module 120, AI architect data 130, an analysis module 140, and an AI architect portal 150. The system 100 also includes customer applications and repositories 160 and customer provisioning system 170. One or more inputs can be received by the integration engine 105 from user accessing the system 100. For example, a customer user 181 can submit inputs to the customer applications and repositories 160, an operations user 183 can submit inputs to the customer provisioning system 170, a data scientist 185 can submit inputs to the analysis module 140, and a customer user 187 can submit inputs to the AI architect portal 150.

According to one or more embodiments, the integration engine 105 acquires data. The data can be within a network of the customer (e.g., as represented by the customer applications and repositories 160). The integration engine 105 can be on-premise, in-cloud, or a combination of both with respect to the network of the customer. The network of the customer (e.g., as represented by the customer applications and repositories 160) can include one or more separate systems using different data organization formats. For example, the customer applications and repositories 160 can include, but is not limited to, flat-file, relational, extensible markup language (XML), JavaScript object notation (JSON), non-relational structures, virtual storage access m(VSAM), indexed sequential access method (ISAM), and other data organization formats. The data can be unstructured and structured data (e.g., customer data within the customer applications and repositories 160). For instance, the customer data can include, but is not limited to, documents, communications, multimedia, database information, and other diverse data types. By way of example, unstructured customer data can be or can be sourced from portable document formats (PDF), workbooks or spreadsheets, charts, presentations, word processing documents, moving picture experts groups (MPEG), etc. By further example, structured customer data can be sourced from a database migration service (DMS), a quality management system (QMS), a manufacturing execution system (MES), a laboratory information management system (LIMS), a structured query language (SQL) server, etc. According to one or more embodiments, the integration engine 105 manages the data as the data alters, changes, expands, contracts, or updates. According to one or more embodiments, the system 100 and the integration engine 105 are adaptable to multiple and alternative formats for and within the data.

According to one or more embodiments, the integration engine 105 provides immutability for the data and reporting. In this regard, immutability refers to maintaining the integrity of data, analytics, outputs, and generated reports, once committed to the integration engine 105 (i.e., the data cannot be altered without creating a clear and auditable record of change). The integration engine 105 maintains write-once or versioned storage for underlying matter documents, extracted text, embeddings, analysis results, and generated metrics, so that each state of the data and each corresponding report is preserved as a fixed historical artifact. Subsequent corrections, annotations, or updates are captured as new versions or overlay records rather than edits to prior entries, thereby ensuring that any retrieval of past reports, dashboards, or metrics reflects exactly what was known and generated at that time. This immutability supports regulatory and ethical obligations, facilitates accurate reconstruction of events and decisions, and provides a defensible audit trail for internal oversight, client reporting, and potential dispute resolution.

The integration engine 105 acquires the data by discovering and digesting (i.e., processing) the unstructured and structured customer data from the network of the customer. The integration engine 105 can utilize the discover and digest module 110 to acquire (represented by arrow 190) the data from the customer applications and repositories 160. According to one or more embodiments, the customer data of the customer applications and repositories 160 can be ingested but not retained by integration engine 105. The customer user 181 can submit inputs, including customer data, configurations, documents, profiles, and other data, to the customer applications and repositories 160. The discover and digest module 110 includes, but is not limited to, information ingestion operations, prebuild connectors, translation operations, indexing and searching operations, data transformations, computer vision, and named entity recognition. For example, the discover and digest module 110 can perform data ingestion, transformation, and translation, including computer vision, audio/video to text conversion, and conversion to structured data.

The discover and digest module 110 can utilize any elements therein, along with web crawlers, data scraping software, application programable interface (API) calls, get operations, pull operations, and other fetching software, to acquire the data from the customer applications and repositories 160. The discover and digest module 110 can utilize any elements therein, along with natural language processing (NLP), AI, generative AI, natural language generation (NLG), machine learning, and other processing software, to digest the data from the customer applications and repositories 160. According to one or more embodiments, the integration engine 105 can user a repeatable rules based transformation operation to digest diverse data types of unstructured and structured data and to identify relevant context therefrom, which can include translating unstructured and structured data into one or more languages (e.g., over 140 languages).

According to one or more embodiments, the integration engine 105 composes narratives. The narratives are contextually relevant descriptions of the data. The narratives can be in text (e.g., documents), audio, or video formats. According to one or more embodiments, the integration engine 105 composes the narratives utilizing the compose module 120 to process the data acquired by the discover and digest module 110. The compose module 120 can include, but is not limited to, generative AI models, dynamic web content generation, text to voice generation, voice to text generation, narrative rules, NLG, and other processing software to compose narratives from the data. For example, the compose module 120 can generates new documents and reports using advanced deterministic NLG.

According to one or more embodiments, the analysis module 140 generates dynamic outputs and narratives with actionable insights, dynamic visualizations, and recommendations. The analysis module 140 can utilize the AI architect data 130. The customer provisioning system 170 works in conjunction with the AI architect data 130 to provide additional data to the AI architect data 130. The customer provisioning system 170 can include, but is not limited to, accounts and configurations. The operations user 183 can submit inputs, including user information, preferences, and other data, to the customer provisioning system 170. For instance, the analysis module 140 provides graph knowledge to capture the AI architect data 130 and the data from the customer applications and repositories 160 and all the relationships enabling informed decision-making and virtual experimentation. Aspects of the analysis module 140 include, but are not limited to, data ecosystem insights, AI, data science operations and algorithms, data visualizations, eco-system digital twins, process monitoring, Unix operating system, chat with data using large language models and/or retrieval augmented generation, and insight narratives. The data scientist 185 can submit inputs, including parameters, selections, constraints, and other credentials, to the analysis module 140.

According to one or more embodiments, the AI architect portal 150 generates one or more user interfaces and/or interface elements for display. Examples of the one or more user interfaces and/or interface elements include, but are not limited to data visualizations, reports, dynamic narratives, graphs, audit trails, tables, and other elements. For example, the AI architect portal 150 can include authenticated, web application for engaging in workflows, consuming generated content, and providing generated content. The customer user 187 can submit inputs, including user inputs, requests, chart selections, ranges, and other data, to the AI architect portal 150. According to one or more embodiments, the system 100 and the integration engine 105 are adaptable to multiple and alternative ML/AI technologies. For example, the system 100 and the integration engine 105 can integrate AI models and emerging data sources related to Internet of Things (IoT) and blockchain, as well as generative pre-trained transforms.

One or more advantages, technical effects, and/or benefits of the integration engine 105 can include time and processes savings. Accordingly, the integration engine 105 and processes herein are concrete, computer-implemented architecture that performs specific technical operations on data and are not high-level analyzing and presenting concepts. Further, the integration engine 105 and processes herein require distinct technical components, such as the discover and digest module 110, the compose module 120, the AI architect data 130, the analysis module 140, and the AI architect portal 150, that interact in a prescribed manner. The discover and digest module 110 acquires data from a customer network, the compose module 120 transforms that raw data into contextually relevant narratives, the analysis module 140 generates dynamic outputs with actionable insights and recommendations based on those narratives, and the AI architect portal 150 presents those dynamic outputs in one or more user interfaces. This modular pipeline specifies how heterogeneous and/or unstructured data is ingested, structured, semantically enriched, and converted into dynamic, insight-bearing outputs within a particular system configuration. Thus, the integration engine 105 is directed to a specific improvement in computer-based data integration and output generation where a structured integration engine continuously processes customer network data into context-aware, dynamic outputs consumable via defined interfaces (rather than to any generic mental process or abstract concept). Operations herein can further be performed in real-time on a scale beyond the capabilities of a human mind, and not practical using a pen or paper given the required speed of operations and required volume of data, which impose concrete technological constraints that humans cannot solve.

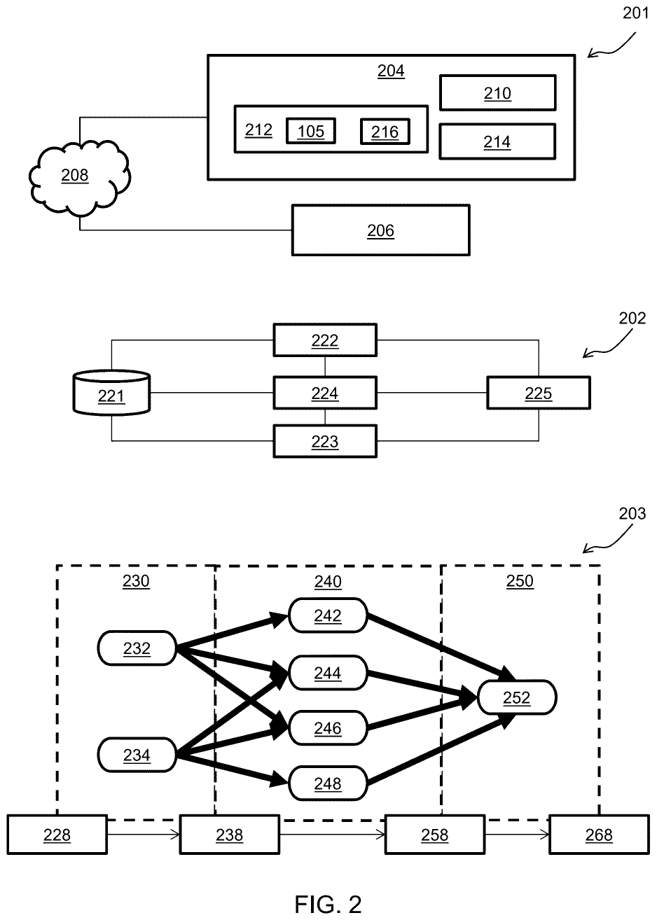

Turning now to FIG. 2, system diagrams 201, 202, and 203 in which one or more features of the disclosure subject matter can be implemented are illustrated according to one or more exemplary embodiments.

The system diagram 201 includes, in relation to an apparatus 204, a local/remote computing device 206, and a network 208. Further, the apparatus 204 can include a processor 210, a memory 212, and a transceiver 214. Note that the integration engine 105 of FIG. 1 is reused in FIG. 2 for ease of explanation and brevity.

According to an embodiment, the system diagram 201 and/or the apparatus 204 can be an example of the system 100 of FIG. 1, or the one or more features therein. According to an embodiment, while the apparatus 204 is shown as a single item in FIG. 2, example systems may include a plurality of apparatuses.

Accordingly, the apparatus 204 and/or the external computing device can be programed to execute computer instructions with respect the integration engine 105 and data 216. As an example, the memory 212 stores these computer instructions for execution by the processor 210 so that the apparatus 204 can perform discover, digest, compose, analyze, and report operations on the data 216 and/or implement machine learning and/or artificial intelligence (ML/AI) in support thereof. In this way, the processor 210 and the memory 212 are representative of processors and memories of the local/remote computing device 206, though not shown in the local/remote computing device 206 of FIG. 2 for ease of explanation and brevity.

The apparatus 204 and/or the local/remote computing device 206 can be any combination of software and/or hardware that individually or collectively store, execute, and implement the integration engine 105 and functions thereof. Further, the apparatus 204 and/or the local/remote computing device 206 can be an electronic, computer framework comprising and/or employing any number and combination of computing device and networks utilizing various communication technologies, as described herein. The apparatus 204 and/or the local/remote computing device 206 can be easily scalable, extensible, and modular, with the ability to change to different services or reconfigure some features independently of others.

The network 208 can be a wired network, a wireless network, or include one or more wired and wireless networks. According to an embodiment, the network 208 can be representative is an example of a short-range network (e.g., local area network (LAN), or personal area network (PAN)). Information can be sent, via the network 208, between the apparatus 204 and the local/remote computing device 206 using any one of various short-range wireless communication protocols, such as Bluetooth, Wi-Fi, Zigbee, Z-Wave, near field communications (NFC), ultra-band, Zigbee, or infrared (IR). Further, the network 208 can be representative of one or more of an Intranet, a local area network (LAN), a wide area network (WAN), a metropolitan area network (MAN), a direct connection or series of connections, a cellular telephone network, or any other network or medium capable of facilitating communication between the apparatus 204 and the local/remote computing device 206. Information can be sent, via the network 208, using any one of various long-range wireless communication protocols (e.g., TCP/IP, HTTP, 3G, 4G/LTE, or 5G/New Radio). Note that, for the network 208, wired connections can be implemented using Ethernet, Universal Serial Bus (USB), RJ-11 or any other wired connection and wireless connections can be implemented using Wi-Fi, WiMAX, and Bluetooth, infrared, cellular networks, satellite or any other wireless connection methodology.

In operation, the apparatus 204 can continually or periodically obtain, monitor, store, process, and communicate the data 216 via the network 208. Further, the apparatus 204, and/or local/remote computing device 206 are in communication through the network 208. For instance, the apparatus 204 can be an example of the system 100 of FIG. 1 configured to communicate with the local/remote computing device 206 via the network 210. The local/remote computing device 206 can be, for example, a stationary/standalone device, a base station, a desktop/laptop computer, a smart phone, a smartwatch, a tablet, or other device configured to communicate with other devices via the network 208. The local/remote computing device 206 can be implemented as a physical server on or connected to the network 208 or as a virtual server in a public cloud computing provider (e.g., Amazon Web Services (AWS)®) of the network 208, can be configured to communicate with the local/remote computing device 206 via the network 208. Thus, the data 216 can be communicated throughout the system diagram 201.

The processor 210, in executing the integration engine 105, can be configured to receive, process, and manage the data, and communicate the data to the memory 212 for storage and/or across the network 208 via the transceiver 214. Data from one or more other apparatuses 204 can also be received by the processor 210 through the transceiver 214. The memory 212 is any non-transitory tangible media, such as magnetic, optical, or electronic memory (e.g., any suitable volatile and/or non-volatile memory, such as random-access memory or a hard disk drive). The memory 212 stores the computer instructions for execution by the processor 210. The transceiver 214 may include a separate transmitter and a separate receiver. Alternatively, the transceiver 214 may include a transmitter and receiver integrated into a single component. In operation, the apparatus 204, utilizing the integration engine 105, acquires the data 216 of the system and composes narratives that are provides across the network 208 via the transceiver 214.

The system diagram 202 illustrates a graphical depiction of ML/AI architecture of the apparatus 204 and the local/remote computing device 206. As shown, the system diagram 202 includes data 221 (e.g., the data 216) that can be stored on a memory or other storage unit (e.g., the memory 212). Further, the system diagram 202 includes a machine 222 and a model 223, which represent software aspects of the integration engine 105 (e.g., ML/AI algorithms therein). The machine 222 and the model 223 operate together, with respect to hardware 224 (e.g., the processor 210), using the data 221, to generate outcomes 225 (e.g., narratives). Further, the machine 222 can operate, with respect to the hardware 224, using the data 221 to train and build the model 223 to predict the outcomes 225. Moreover, the model 223 is built on the data 221. Building the model 223 can include physical hardware or software modeling, algorithmic modeling, and/or the like that seeks to represent the data 221 (or subsets thereof) that has been collected and trained. In some aspects, building of the model 223 is part of self-training operations by the machine 222. The model 223 can be configured to model the operation of hardware 224 and model the data 221.

The model 223 can include neural networks. In general, a neural network is a network or circuit of neurons, or in a modern sense, an artificial neural network (ANN), composed of artificial neurons or nodes or cells. For example, an ANN involves a network of processing elements (artificial neurons) which can exhibit complex global behavior, determined by the connections between the processing elements and element parameters. These connections of the network or circuit of neurons are modeled as weights. A positive weight reflects an excitatory connection, while negative values mean inhibitory connections. Inputs are modified by a weight and summed using a linear combination. An activation function may control the amplitude of the output. For example, an acceptable range of output is usually between 0 and 1, or it could be −1 and 1. In most cases, the ANN is an adaptive system that changes its structure based on external or internal information that flows through the network.

In more practical terms, neural networks are non-linear statistical data modeling or decision-making tools that can be used to model complex relationships between inputs and outputs or to find patterns in data. Thus, ANNs may be used for predictive modeling and adaptive control applications, while being trained via a dataset. Note that self-learning resulting from experience can occur within ANNs, which can derive conclusions from a complex and seemingly unrelated set of information. The utility of artificial neural network models lies in the fact that they can be used to infer a function from observations and also to use it. Unsupervised neural networks can also be used to learn representations of the input that capture the salient characteristics of the input distribution, and more recently, deep learning algorithms, which can implicitly learn the distribution function of the observed data. Learning in neural networks is particularly useful in applications where the complexity of the data (e.g., the data 221) or task (e.g., composing narratives) makes the design of such functions by hand or by human action impractical. According to one or more embodiments, the neural networks of the model 223 can include regression analysis (e.g., function approximation) including time series prediction and modeling; classification including pattern and sequence recognition; novelty detection and sequential decision making; data processing including filtering; clustering; blind signal separation; and compression. According to one or more embodiments, the neural networks of the model 223 can implement a long short-term memory neural network architecture, a convolutional neural network (CNN) architecture, or other the like. The neural network can be configurable with respect to a number of layers, a number of connections (e.g., encoder/decoder connections), a regularization technique (e.g., dropout); and an optimization feature.

The system diagram 203 illustrates a graphical depiction of neural network and process of the model 223. In an example operation, with respect to block 228, the model 223 includes collecting the data 221 in an input layer 230, as represented by a plurality of inputs (e.g., inputs 232 and 234). That is, the input layer 230 receives the inputs 232 and 234. At block 238, the neural network of the model 223 encodes the plurality of inputs utilizing any portion of the data 221 to produce a latent representation or data coding. The latent representation includes one or more intermediary data representations derived from the plurality of inputs. According to one or more embodiments, the latent representation is generated by an element-wise activation function (e.g., a sigmoid function or a rectified linear unit) of the integration engine 105. Accordingly, the plurality of inputs are provided to a hidden layer 240 depicted as including nodes 242, 244, 246, and 248. The neural network performs processing via the hidden layer 240 of the nodes 242, 244, 246, and 248 to exhibit complex global behavior, determined by the connections between the processing elements and element parameters. Thus, the transition between layers 230 and 240 can be considered an encoder stage that takes the inputs 232 and 234 and transfers it to a deep neural network (within layer 240) to learn some smaller representation of the input (e.g., a resulting the latent representation). The deep neural network can be a CNN, a long short-term memory neural network, a fully connected neural network, or combination thereof. This encoding provides a dimensionality reduction of the inputs 232 and 234. Dimensionality reduction is a process of reducing the number of random variables (of the inputs 232 and 234) under consideration by obtaining a set of principal variables. For instance, dimensionality reduction can be a feature extraction that transforms data (e.g., the inputs 232 and 234) from a high-dimensional space (e.g., more than 10 dimensions) to a lower-dimensional space (e.g., 2-3 dimensions). The technical effects and benefits of dimensionality reduction include reducing time and storage space requirements for the data 221, improving visualization of the data 221, and improving parameter interpretation for machine learning. This data transformation can be linear or nonlinear. The operations of receiving (block 228) and encoding (block 238) can be considered a data preparation portion of the multi-step data manipulation by the integration engine 105.

At block 258, the neural network of the model 223 decodes the latent representation. The decoding stage takes the encoder output (e.g., the resulting the latent representation) and attempts to reconstruct some form of the inputs 232 and 234 using another deep neural network. In this regard, the nodes 242, 244, 246, and 248 are combined to produce, in an output layer 250, an output 252. That is, the output layer 250 reconstructs the inputs 232 and 234 on a reduced dimension but without the signal interferences, signal artifacts, and signal noise. Examples of the output 252 include cleaned data (e.g., clean/denoised version of data). At block 268, the model 223 provides the output 252.

The system diagram 201 is directed to a specific computer-based integration engine and modular system architecture, including ML/AI model integration and “data pipes” that provide resilient, traceable, auditable, and transparent end-to-end data paths—rather than to a mental process that could be performed in the human mind. These features reflect a concrete improvement to the functioning of a computer system itself (e.g., enabling efficient swapping of ML/AI models and tools, scalable composition/analysis/reporting, and direct source-to-result matching) and are inherently tied to computer technology, such that they cannot practically be implemented as purely mental steps. Accordingly, the system diagram 201 is not “directed to” an abstract idea or, at a minimum, recites significantly more than any underlying abstract concept by specifying a particular machine-implemented architecture that effects a technological improvement in data processing systems.

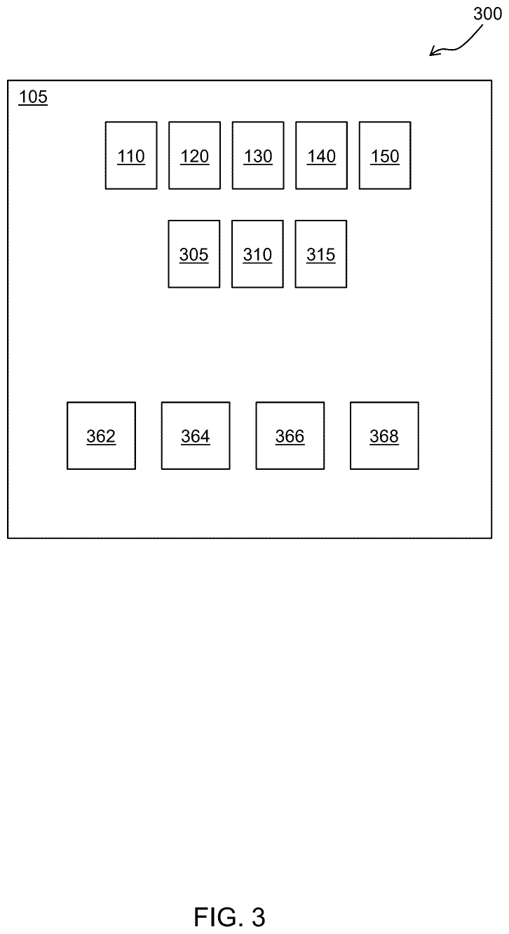

FIG. 3 illustrates an example architecture 300 of the integration engine 105 according to one or more embodiments. Generally, the example architecture 300 of the integration engine 105 integrates and combines multiple interchangeable software components using custom data pipes. By way of example, the example architecture 300 of the integration engine 105 can include components including, but not limited to, a security model 305, a graph model 310, and an AI research and development model 315, as well as the discover and digest module 110, compose module 120, the AI architect data 130, the analysis module 140, and the AI architect portal 150 as described herein. By way of further example, the example architecture 300 of the integration engine 105 can connect to and include a technology stack. The technology stack can include, but not limited to, a business portal 362, a service layer 364, processing layer 366, and a storage layer 368.

The security model 305 of integration engine 105 can utilize ML/AI and/or provide authentication (e.g., a cognito authentication services) and other features/modules. Further, example of the others features/modules can include a self-serve password reset, single sign-on, multifactor authentication, and application security. The security model 305 of integration engine 105 can include roles for limiting access to data and application functionality, audit trails (e.g., mapping of outputs), and multi-tenant modules. Audit trails can include data changes, configuration changes, AI model changes, transformation changes, and password resets and role changes. Multi-tenant modules can include no comingling of data in any repository and an option for having the solution completely behind customer's firewall.

The graph model 310 of integration engine 105 can utilize ML/AI and/or model entire ecosystems, provide product quality analysis from commercialization to post market surveillance, graph clinical supply networks, determine drug development candidates based on patient data and pharmacodynamics, model environmental ecosystems and economic impacts, model data flows and AI transformations. The graph model 310 can also deliver mapping of output back to systems of record (e.g., audit trail), provide explainable AI (e.g., AIX) for the transformed data and generated output, and graph improved performance and quality of “Ask Your Data” processes.

The AI research and development model 315 of the integration engine 105 can include real-time identification of drug discovery and development. According to one or more embodiments, the AI research and development model 315 can identify in real-time potential drug targets based on modeled interactions, between genes, proteins, and diseases, by indexing documents, biological information from public databases, lab experiments and clinical trials. Generative AI of the integration engine 105 can create reports with comprehensive knowledge graphs on potential drug targets and supporting evidence. Conversational AI of the integration engine 105 can provide instant detailed answers to specific questions with data. As a process, the AI research and development model 315 of the integration engine 105 can perform synthetic biology, optimizations, scale-ups, and commercialize.

According to one or more embodiments, the business portal 362 of the technology stack provides one or more content delivery networks. The one or more content delivery networks can include a globally-distributed network of proxy servers to cache content (e.g., web videos or other media) locally to improve access and downloading speed for of the content. Examples of the one or more content delivery networks includes Amazon CloudFront, Google Cloud CDN, Varnish Software, Imperva App Protect, and Netlify.

According to one or more embodiments, the service layer 364 provides data-driven responses utilizing NLP, generative AI, and/or NLG software. Examples of NLP, generative AI, and/or NLG software of the service layer 364 include Arria, ReAct, Quill, Wordsmith, and Phrazor.

According to one or more embodiments, the processing layer 366 provides extract, transform, and load (ETL) operations, as well as graph database management system (GDBMS). The processing layer 366 can provide NPL and data science. Examples of the ETL operations, GDBMS, NPL, and data science of the processing layer 366 include docxonomy, neo4j, Amazon Reshift, and Google BigQUery.

According to one or more embodiments, the storage layer 368 provides a data warehouse and lake. Examples of the data warehouse and lake of the service layer 364 include neo4j and Amazon S3.

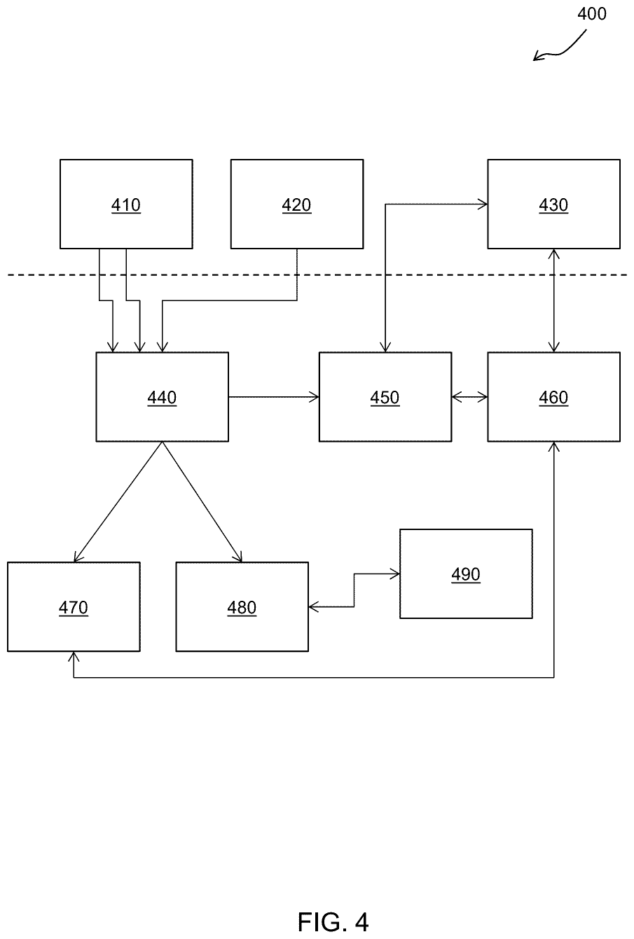

FIG. 4 illustrates a logical architecture 400 according to one or more embodiments. Generally, the logical architecture 400 of the integration engine 105 integrates and combines multiple interchangeable software components using custom data pipes. The logical architecture 400 can include client application and repositories 410, client application and repositories 420, AI architect portal 430, AI architect discover docxonomy 440, AI architect compose aria 450, AI architect analyze neo4j 460, AI architect graph data neo4j repository 470, AI architect SQL data 480, and account and user management 490. According to one or more embodiments, the integration engine 105 can analyze/report in combination (e.g., data visualization; charts; graphs; and beyond charting to provide a sophisticated graph technology).

The logical architecture 400 provides/discovers connectors (e.g., data pipes), which can include pre-built and custom API to ingest information. Note that each client's data is separate (e.g., no comingling of data). The logical architecture 400 provides a connector (e.g., Discover API), which can be used to supply structured data to downstream applications. The logical architecture 400 provides cloud services (e.g., AWS microservices, Cognito, S3, etc.), SQL containers, SQL configurations, and transactional data The logical architecture 400 provides/discovers connectors (e.g., pre-built connectors) to pull information from client application and repositories 410 and client application and repositories 420. The logical architecture 400 provides/discovers/generates narratives, video, and/or audio. The logical architecture 400 provides ML algorithms to model processes and ecosystems. The logical architecture 400 provides/discovers authentication and encryption. The logical architecture 400 provides/discovers API Management for ingestion and publishing data. According to one or more embodiments, the connector or data pipe of the logical architecture 400 that provides a resilient, traceable, auditable, and transparent path that directly matches data from sources to results and/or analyses. By way of example, Accordingly,, the connector or data pipe of the logical architecture 400 are “tuned specifically” for the use case or requirements. Use case or requirements include, but are not limited to, gaining processing efficiencies for accounting software where the data is multimodal across both public and private location. The connector or data pipe provides tagging named entity recognition and transforming data that can be stored. The connector or data pipe can be built from aspect of an output to data groups (e.g., if a form has 88 fields, then the data for each field can be found).

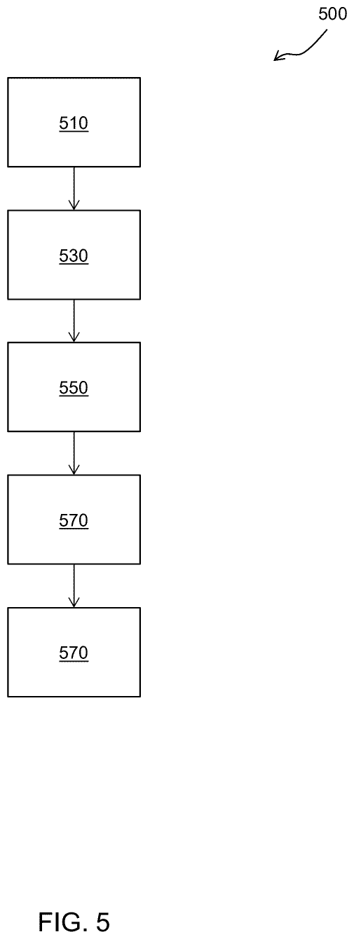

FIG. 5 illustrates a method 500 according to one or more embodiments. The method 500 depicts operations by the integration engine 105, including discover (block 510), digest (block 530), compose (block 550), analyze (block 570), and report (block 590) operations that provide technical benefits, advantages, and improvements over conventional technologies. According to one or more embodiments, the integration engine 105 is scalable, i.e., can grow or adjust with demand or data volume.

At blocks 510 and 520, the discover and digest module 110 of the integration engine 105 acquires (discovers and digests) data from a customer network. The integration engine 105 manages changing the data as the integration engine 105 alters, expands, contracts, or updates the data over time.

At block 550, the compose module 120 of the integration engine 104 composes narratives to provide contextually relevant descriptions of the data.

At block 570, the analysis module 140 of the integration engine 105 generates dynamic outputs with actionable insights and recommendations of the narratives. The dynamic outputs can include one or more data visualizations, chat dialogues, audio, etc. The dynamic outputs can be used for decision intelligence and/or cascading decisions, such that any data pipes are maintained.

At block 590, the AI architect portal 150 of the integration engine 105 presents the dynamic outputs in one or more user interfaces.

According to one or more embodiments, the integration engine 105 can provide AI in ribonucleic acid (RNA) sequencing, which include leveraging heterogeneous networks for RNA sequencing-based tumor Diagnosis. A heterogeneous network (hetnet) of the integration engine 105 can be a complex data structure that integrates multiple types of nodes and relationships, representing diverse biomedical data. The hetnet of the integration engine 105 models interactions between biological entities, such as genes, diseases, and drugs, allowing for a more holistic understanding of complex biological systems. The hetnet of the integration engine 105 can be used in various biomedical applications, including drug repurposing.

According to one or more embodiments, the integration engine 105 can provide relevance to RNA sequencing. RNA sequencing (RNA-seq) generates detailed gene expression profiles, creating vast data sets. Analyzing RNA-seq data within the context of clinical outcomes can yield insights into tumor diagnosis and prognosis. The hetnets can be adapted to model RNA sequence interactions with clinical outcomes, aiding in predictive diagnostics.

According to one or more embodiments, the integration engine 105 can provide custom hetnet for tumor diagnosis and prognosis. Building the hetnets for RNA-seq can include nodes that represent RNA sequences, genes, tumor types, and clinical outcomes and edges that Define relationships, such as RNA expression-gene associations, RNA-tumor type correlations, and RNA-clinical outcome links. The integration engine 105 can utilize the existing framework of heterogeneous networks to integrate RNA-seq data with clinical and biological datasets.

According to one or more embodiments, the integration engine 105 can provide data integration. Data integration can incorporate RNA-seq data from public repositories (e.g., TCGA) into the heterogeneous network. Data integration can integrate clinical outcome data to establish connections between RNA expression patterns and tumor progression or treatment response. Data integration can use standardized ontologies (like Gene Ontology) for consistent node definitions.

According to one or more embodiments, the integration engine 105 can provide predictive modeling for tumor diagnosis using hetnets. According to one or more embodiments, the integration engine 105 can provide feature engineering that can use metrics like Degree-Weighted Path Count (DWPC) to identify significant paths between RNA sequences and clinical outcomes within the network. According to one or more embodiments, the integration engine 105 can develop features based on these paths to serve as inputs for machine learning models.

According to one or more embodiments, the integration engine 105 can provide model adaptation to adapt existing logistic regression models used in hetnets for predicting drug efficacy to instead predict tumor types and prognoses based on RNA-seq data. Ensure the model generalizes well and accurately predicts clinical outcomes through cross-validation.

According to one or more embodiments, the integration engine 105 can provide network visualizations that implement visualization tools to map out relationships within the hetnets. These tools help clinicians and researchers interpret connections between RNA sequences and tumor characteristics, making the data actionable.

According to one or more embodiments, the integration engine 105 can be applied to supply chain and compound supply and clinical supply with tracking.

According to one or more embodiments, the integration engine 105 is scalable to manage growing data volumes, integrate technologies, and support ML/AI.

According to one or more embodiments, a versatility of the system 100 and the integration engine 105 provides for a number of use cases including, but not limited to personalized medicine, compliance monitoring, logistics, life science, and other areas

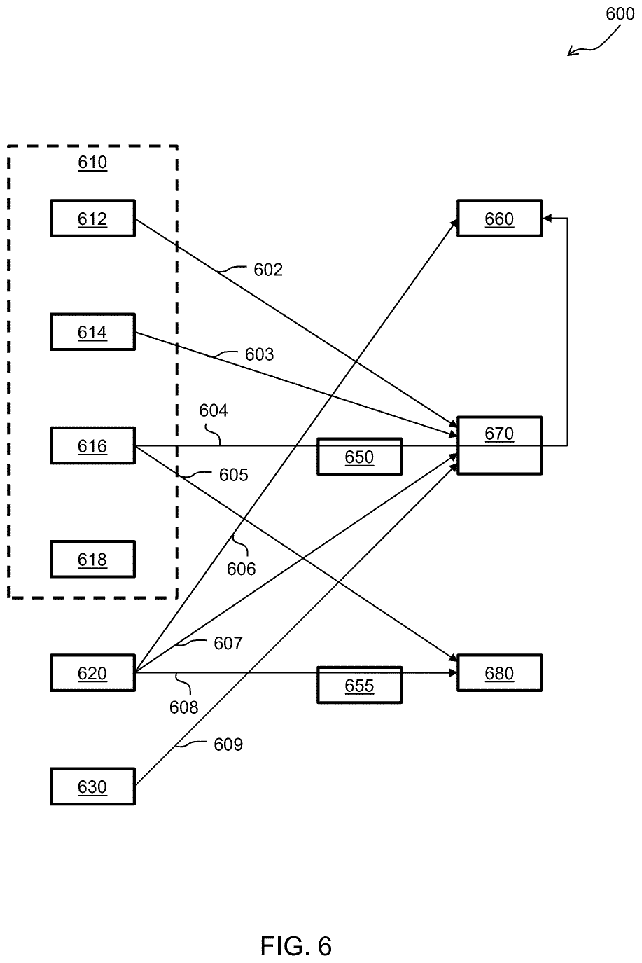

FIG. 6 illustrates a diagram 600 according to one or more embodiments. The diagram 600 includes data pipes 602, 603, 604, 605, 606, 607, 608, and 609, which can be direct clean transparent auditable paths that include connectors and/or web hooks (e.g., resilient, traceable, auditable, and transparent). The diagram 600 includes one or more sources include a client system 610 with a first database 612, a second database 614, a third database 616, and a fourth database 618. The one or more sources include a public data repository 620 and a proprietary database 630. The diagram 600 provides a result 650 and a result 655. The diagram provides an analysis 660, an analysis 670, and a report 680. The data pipes 602, 603, 604, 605, 606, 607, 608, and 609 connect data of the one or more sources to the result 650, the result 655, the analysis 660, the analysis 670, and the report 680. By way of example, an end goal (e.g., the analysis 660) and a prior version (e.g., the analysis 670) of the end goal that is correct are presented to the system 100 and the integration engine 105, the integration engine 105 trains, produces a score (e.g., confidence scores), and connects the one or more sources. then point to the database.

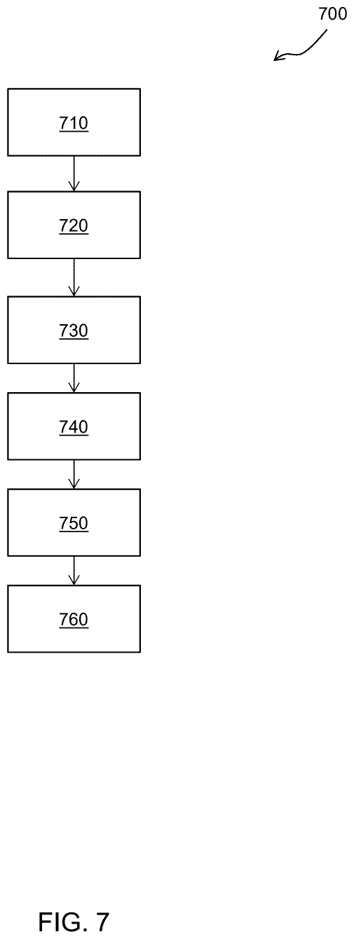

FIG. 7 illustrates a method 700 according to one or more embodiments. The method 700 depicts operations by the integration engine 105. Generally, the method 700 depicts a build cycle integration that represents an exemplary construction project lifecycle, with data ingestion feeding every stage to create a continuous, intelligence-driven process. From the moment project documents are received (e.g., acquired/digested) through final closeout (reporting), information is captured, organized, analyzed, and fed forward to support better decisions and reduce risk.

At block 710, the integration engine 105 performs an intake. The intake operation begins when project documents are uploaded and classified. At this point, an initial specification screening is conducted to understand the job's basic parameters. Key data, such as division mapping, file types, and overall project scope, is captured and structured. An example outcome of the intake operation is an organized document library ready for more detailed analysis in subsequent phases.

At block 720, the integration engine 105 performs a deep dive. The deep dive operation focuses on achieving a comprehensive understanding of the project. A specification analysis module is applied to review the technical and commercial requirements. Cost estimation is reviewed to ensure alignment with the scope, and potential risks are identified early. By the end of this stage, stakeholders have a thorough view of the project's requirements, constraints, and risk profile.

At block 730, the integration engine 105 performs scoring. The scoring operation quantifies what has been learned so far. The project is evaluated division by division, and a six-dimension risk assessment is conducted. Bid coverage is scored to understand how well the project is supported by available pricing and participation. AI-driven analysis is applied across specifications, cost, bid data, and risk factors. The output of this stage is a clear, quantified view of both project risk and opportunity.

At block 740, the integration engine 105 performs an award operation. The award operation turns analysis into contractual commitments. Bids are compared, and selections are made based on the earlier scoring and risk assessments. Subcontractor buyout is managed to lock in pricing and participation. Contracts are executed, resulting in a contracted scope with clearly defined deliverables and responsibilities.

At block 750, the integration engine 105 performs a construction operation. The construction operation is where the project is executed in the field, supported by ongoing control and visibility. Requests for Information (RFIs) are managed to clarify ambiguities, change orders are tracked to capture scope and cost impacts, and progress is monitored against the plan. The outcome is a controlled project execution environment that helps maintain schedule, budget, and quality.

At block 760, the integration engine 105 performs a close-out operation. The close-out operation ensures that the project is formally completed and that organizational learning is captured. Punch list items are managed to resolution, final documentation is assembled and archived, and lessons learned are documented. This stage produces not only project completion but also long-term knowledge retention that can be leveraged to improve performance on future projects.

According to one or more embodiments, the build cycle integration can include a matter lifecycle integration method to complete legal matter workflow, with data ingestion feeding every stage of the process. The integration engine 105 creates a new matter, i.e., a new matter is opened within the system 100. The integration engine 105 selects the appropriate client, designates the matter type (e.g., such as a patent or a trademark), and selects the relevant filing type, which can be captured by a matter record. The matter record is established and ready to receive document uploads.

Next, the integration engine 105 receives and adds matter-related files. As documents are uploaded, the integration engine 105 automatically tags the documents by document type, performs text extraction (for example, via a TextExtractor Lambda), and generates vector embeddings (for example, using Cohere Embed v4). The output can include a searchable document corpus associated with the new matter.

Next, the integration engine 105 can apply an AI-driven analysis to the ingested data. A Retrieval-Augmented Generation (RAG)-based question-and-answer module enables users to query the matter record. A shadow examiner component may predict potential rejections, while additional tools support prior art analysis and claims analysis. The output can include AI-powered insights that inform strategy and decision-making for the matter.

Next, the integration engine 105 assists with work product generation. The integration engine 105 supports drafting office action responses, generating United States Patent and Trademark Office (USPTO) forms, and creating template-based responses. The integration engine 105 can also integrate citations to relevant sections of the Manual of Patent Examining Procedure (MPEP) or Trademark Manual of Examining Procedure (TMEP)directly into the draft materials. The output can include a set of draft response documents ready for attorney review.

Next, the integration engine 105 performs a review, which can be coupled with a dedicated review interface to examine, edit, and approve the draft documents. The integration engine 105 provides final document preparation and tracks deadlines associated with the matter to ensure timely filings. The integration engine 105 produces filing-ready documents that have been reviewed and approved.

Next, the integration engine 105 brings the matter to a close. The integration engine 105 provides formal matter closure actions, archives the associated documents, and tracks success metrics related to the matter outcome. Information gained during the matter is used to enrich a broader knowledge base, resulting in a closed matter with a full, searchable history that can inform future work.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. A computer readable medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire

Examples of computer-readable media include electrical signals (transmitted over wired or wireless connections) and computer-readable storage media. Examples of computer-readable storage media include, but are not limited to, a register, cache memory, semiconductor memory devices, magnetic media such as internal hard disks and removable disks, magneto-optical media, optical media such as compact disks (CD) and digital versatile disks (DVDs), a random access memory (RAM), a read-only memory (ROM), an erasable programmable read-only memory (EPROM or Flash memory), a static random access memory (SRAM), and a memory stick. A processor in association with software may be used to implement a radio frequency transceiver for use in a terminal, base station, or any host computer.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments herein have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
acquiring, by a discover and digest module of an integration engine, data from a customer network;
composing, by a compose module of the integration engine, narratives to provide contextually relevant descriptions of the data;
generating, by an analysis module of the integration engine, dynamic outputs with actionable insights and recommendations of the narratives; and
presenting, by an architect portal of the integration engine, the dynamic outputs in one or more user interfaces.

2. The method of claim 1, wherein the integration engine is scalable.

3. The method of claim 1, wherein the integration engine manages the data as the data is altered, changed, expanded, contracted, or updated.

4. The method of claim 1, wherein the integration engine or any of the discover and digest, the compose, and the analysis modules comprise one or more machine learning or artificial intelligence models.

5. The method of claim 1, wherein the integration engine generates one or more data pipes that provide one or more paths from portions of the data to the dynamic outputs.

6. The method of claim 5, wherein each of the one or more data pipes is tuned to obtain, from all available unstructured and structured data, a subset of the data relevant to a particular use case or requirement.

7. The method of claim 1, wherein the dynamic outputs comprise a data visualization, a chart, a graph, a dynamic narrative, a chat dialogue, an audio output, a video output, or a report document that is usable for decision intelligence or cascading decisions.

8. The method of claim 1, wherein the method comprises digesting unstructured and structured information as the data using one or more repeatable rules-based transformations to identify relevant context within the unstructured and structured data.

9. The method of claim 1, wherein unstructured and structured information as the data comprises project-related data for a project.

10. The method of claim 1, wherein the method comprises a build cycle operation.

11. A system comprising:
a memory storing program code for an integration engine; and
at least one processor executing the program code to cause the system to perform:
acquiring, by a discover and digest module of the integration engine, data from a customer network;
composing, by a compose module of the integration engine, narratives to provide contextually relevant descriptions of the data;
generating, by an analysis module of the integration engine, dynamic outputs with actionable insights and recommendations of the narratives; and
presenting, by an architect portal of the integration engine, the dynamic outputs in one or more user interfaces.

12. The system of claim 11, wherein the integration engine is scalable.

13. The system of claim 11, wherein the integration engine manages the data as the data is altered, changed, expanded, contracted, or updated.

14. The system of claim 11, wherein the integration engine or any of the discover and digest, the compose, and the analysis modules comprise one or more machine learning or artificial intelligence models.

15. The system of claim 11, wherein the integration engine generates one or more data pipes that provide one or more paths from portions of the data to the dynamic outputs.

16. The method of claim 15, wherein each of the one or more data pipes is tuned to obtain, from all available unstructured and structured data, a subset of the data relevant to a particular use case or requirement.

17. The system of claim 11, wherein the dynamic outputs comprise a data visualization, a chart, a graph, a dynamic narrative, a chat dialogue, an audio output, a video output, or a report document that is usable for decision intelligence or cascading decisions.

18. The system of claim 11, wherein the method comprises digesting unstructured and structured information as the data using one or more repeatable rules-based transformations to identify relevant context within the unstructured and structured data.

19. The system of claim 11, wherein unstructured and structured information as the data comprises project-related data for a project.

20. The system of claim 11, wherein the at least one processor executing the program code to cause the system to perform a build cycle operation.
